(19) United States
(12) Patent Application Publication
(10) Pub. No.: US 2002/0120549 A1
(43) Pub. Date: Aug. 29, 2002

(54) Online trade web site management system

(76) Inventor: Chen-Shi Yang, Shi-Chih City (TW)

Correspondence Address: DOUGHERTY & TROXELL, Suite 1404, 5205 Leesburg Pike, Falls Church, VA, 22041, US

(21) Appl. No.: 09/791,718

(22) Filed: Feb. 26, 2001

(51) Int. Cl. G06F 17/60

(52) U.S. Cl. 705/37; 705/26

(57) ABSTRACT

A business web site is set up in a server of an enterprise. The business web site allows a trader to carry out electronic trade with a plurality of suppliers and a plurality of clients. The business web site is principally based on the setup of an enterprise web site management system. The enterprise web site management system comprises: an enterprise information management system, a supplier information management system, a client information management system, and an enterprise web site information management system. The present invention provides a web site that can integrate the enterprise information and its supplier, and client information, and set up an electronic trade, such that an effective electronic business is obtained.

### BACKGROUND OF THE INVENTION

The present invention provides an online trade web site management system. More particularly, the present invention provides a trade web site management system that addresses to an online purchase and sale processes carried through internet.

Description of the Related Art

Conventionally, the enterprise purchase model is that in which purchase employees of the enterprise perform purchase. Only after the enterprise employees pointed out the demands, then the purchase employees can inquiry, compare, and negotiate the prices of products to be purchased from the suppliers. The order of the products is performed only after inquiry and negotiation of purchase prices are achieved. Such a purchase process is time consuming, and has other drawbacks such as a complete confidence in the purchase employees of the enterprise, non-opened negotiation process. And, if an experienced purchase employee happens to quit the company, a newly employed purchase employee cannot learn immediately the know-how acquired by the former purchase employee, and needs to learn from scratch. Moreover, since the information of the products to be purchased from the suppliers is not easy to obtain, the desired products are hardly obtained through a single purchase process and the purchase order conventionally needs to be carried out separately with each of the suppliers.

Besides, an e-shopping trading model may be so far widespread, but it only shows show the products of the enterprise on a business web site. Consequently, its advantage is limited to a reduction of the shop-window and a replacement of the shop cost. The whole trade management of the enterprise thus still relies on conventional processes of sales, products management, manufactures, purchases and accountant departments. Moreover, although many enterprises may currently use sale-storing software applications, but most of those software applications only provide data records and paperwork management functions, while information analysis and decision propositions are critically missing. As a result, conventional human resource for purchase, sales, management, and accounting cannot be entirely replaced. Moreover, the integration of the information related to the client and the information related to the supplier cannot be performed. This lack of information integration causes the enterprise not to be able to make the correct decisions at critical moment, which affects the adaptation ability of the enterprise.

In the presently context in which electronic processes are commonly employed inside the enterprise, an issue arises about a replenishment/sale/stock software application that would be adapted to each enterprise and set up all the resource information of the enterprise. The replenishment/sale/stock software applications that are currently used can be adapted with difficulty to each enterprise operating model, and their roles are limited to manage enterprise internal information, while an integration of supplier and client resources or information critically misses.

### SUMMARY OF THE INVENTION

A major aspect of the present invention is to provide an online trade web site management system that can manage the enterprise internal information and the supplier and client information, such that expenditure and labor cost of a web site setup and maintenance can be economized while supplier and client resources can be integrated.

Accordingly, one object of the present invention is to provide an online trade web site management system that can simply set up the enterprise information.

According to another object of the present invention, the present invention provides an online trade web site management system that does not necessitate an expenditure and labor cost associated with the web site setup and maintenance.

Still, according to another object of the present invention, the present invention provides online trade web site management system that can provide a simplified purchase process, such that the labor cost can be reduced.

Further, according to another object of the present invention, the present invention provides online trade web site management system that can improve the management efficiency of sales process and open to international market through internet, such that the enterprise products sales can be increased creating business profit.

Further, according to another object of the present invention, the present invention provides online trade web site management system that can integrate the enterprise internal resources and the supplier and client resources, such that a replenishment/sale/stock management can be attained.

### BRIEF DESCRIPTION OF THE DRAWINGS

The objects, features and advantages of the present invention will be better understood through the following detailed description with the help of the accompanying drawings, wherein:

FIG. 1 is a diagram illustrating the online trade web site according to an embodiment of the present invention;

FIG. 2 is a diagram illustrating the online trade web site management system according to an embodiment of the present invention;

FIG. 3 is a diagram illustrating the enterprise information management system according to an embodiment of the present invention;

FIG. 3A is a flow chart illustrating an enterprise basic information management process according to an embodiment of the present invention;

FIG. 3B is a flow chart illustrating a department information management process according to an embodiment of the present invention;

FIG. 3C is a flow chart illustrating an employee information management process according to an embodiment of the present invention;

FIG. 3D is a flow chart illustrating an enterprise product information management process according to an embodiment of the present invention;

FIG. 4 is a diagram illustrating a supplier information management system according to an embodiment of the present invention;

FIG. 4A is a flow chart illustrating a supplier product information management process according to an embodiment of the present invention;

FIG. 4B is a flow chart illustrating a supplier basic information management process according to an embodiment of the present invention;

FIG. 5 is a flow chart illustrating a client information management process according to an embodiment of the present invention;

FIG. 6 is a diagram illustrating a structure of an enterprise web page information management according to an embodiment of the present invention;

FIG. 6A is a flow chart illustrating a post offer information processing according to an embodiment of the present invention;

FIG. 6B is a flow chart illustrating an enterprise announcement information processing according to an embodiment of the present invention;

FIG. 6C is a flow chart illustrating an advertisement information processing according to an embodiment of the present invention; and

FIG. 6D is a flow chart illustrating an enterprise logotype information processing according to an embodiment of the present invention.

### DETAILED DESCRIPTION OF THE PREFERRED EMBODIMENTS

The following description of the present invention is intended to be illustrative only and not limiting, and like reference numerals are used for like and corresponding parts of various drawings.

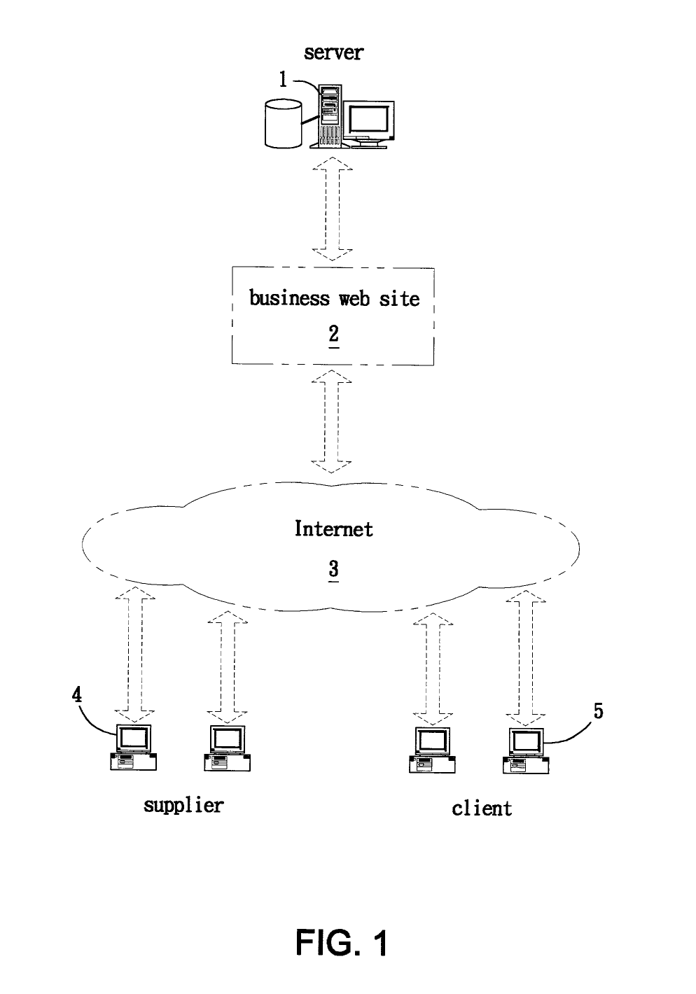

Referring now to FIG. 1, a diagram shows the setup of a web site to carry out online trade through internet, according to a preferred embodiment of the present invention. A business web site 2 is set up in a server 1 of an enterprise. The business web site 2 allows a trader of the enterprise, through internet 3, to carry out purchase processes with a plurality of suppliers 4 and sale processes with a plurality of clients 5. Each of the suppliers 4 and each of the clients 5 also can connect to internet 3 and register into the business web site 2 to trade with the enterprise. The trading model of the present invention, between the enterprise and the suppliers and between the enterprise and the clients, is according to the trading model disclosed in the patent application no. 89127192, “Computer online trading method for integrating sale and purchase processes and a -system for the same”, filed on Dec. 19, 2000 in Taiwan. The web page format of the business web site 2 is written in conventional languages as HTML, JAVA SCRIPT, SQL and JSP, and includes the use of conventional cast structure, object oriented technology and interactive interface. The hardware that is employed to connect to internet comprises a computer, a modem, a xDSL modem, a cable modem, ADSL lines, etc, while the software applications that are used comprises web page browser and email sender/receiver.

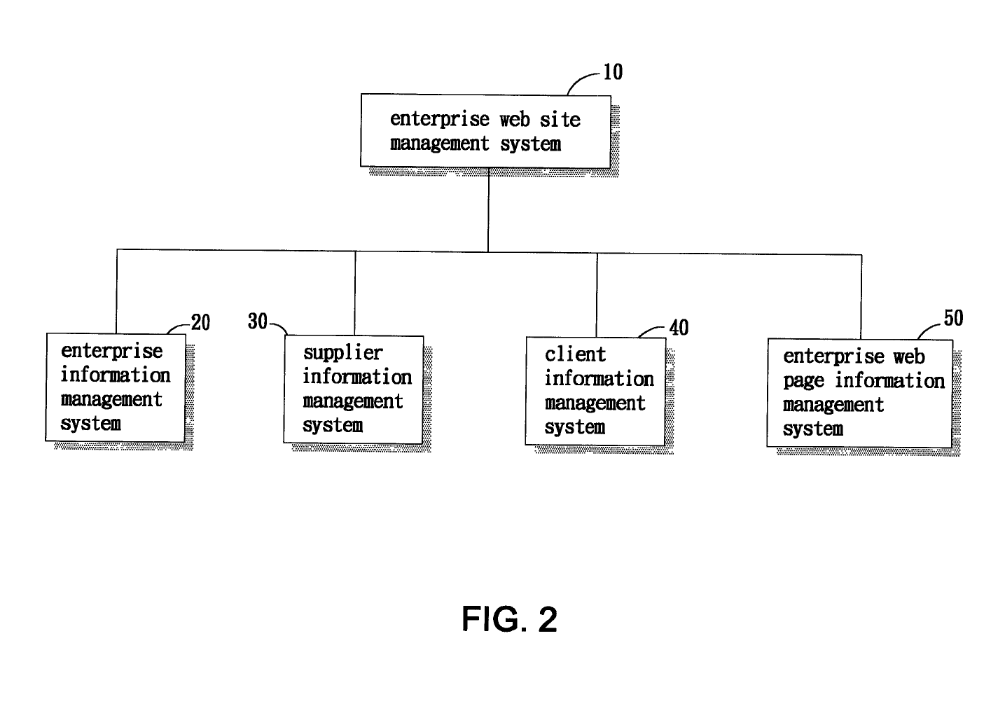

Referring to FIG. 2, a block diagram shows the online trade web site management system, according to an embodiment of the invention. As described above, the business web site 2 is set up in the server 1 of the enterprise. The business web site 2 is principally built up from an enterprise web site management system 10. The enterprise web site management system 10 principally permits the trader to easily integrate the enterprise internal resources, the supplier resources, and the client resources, such that an electronic business can be established.

The enterprise web site management system 10 comprises: an enterprise information management system 20, a supplier information management system 30, a client information management system 40, and an enterprise web page information management system 50. The enterprise information management system 20 principally sets up and carries out maintenance of the enterprise basic information, including also maintenance of department information, employees' information, and product information. The supplier information management system 30 principally sets up and carries out maintenance of the supplier basic information, also including maintenance of the supplier product information. The client information management system 40 principally sets up and carries out maintenance of the client basic information. The enterprise web site information management system 50 principally sets up and carries out maintenance of the web page information comprising post offers, enterprise announcements, advertisement management and enterprise logotype.

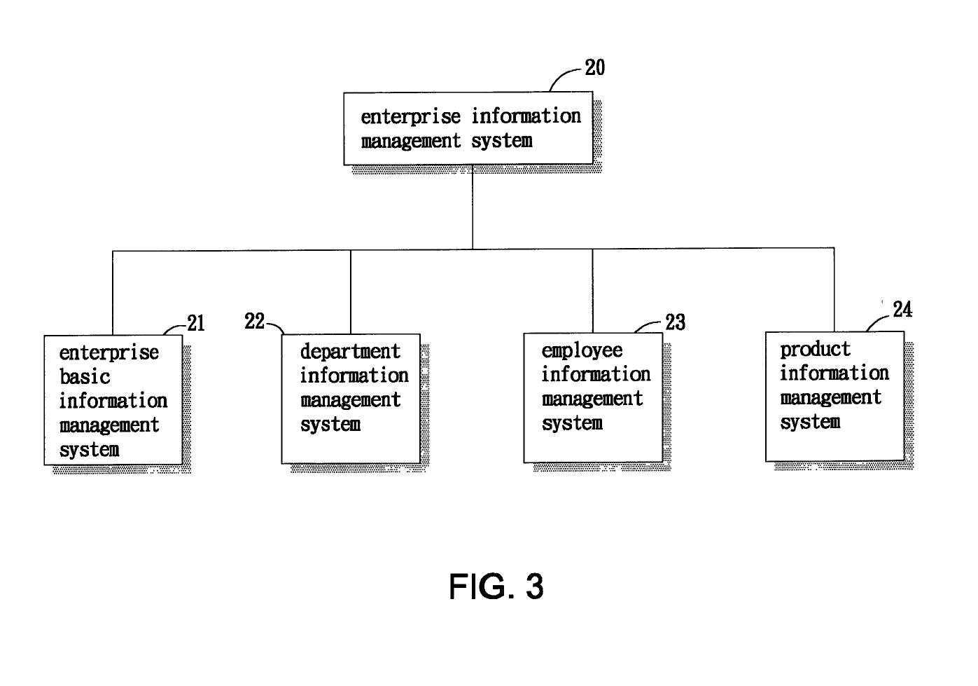

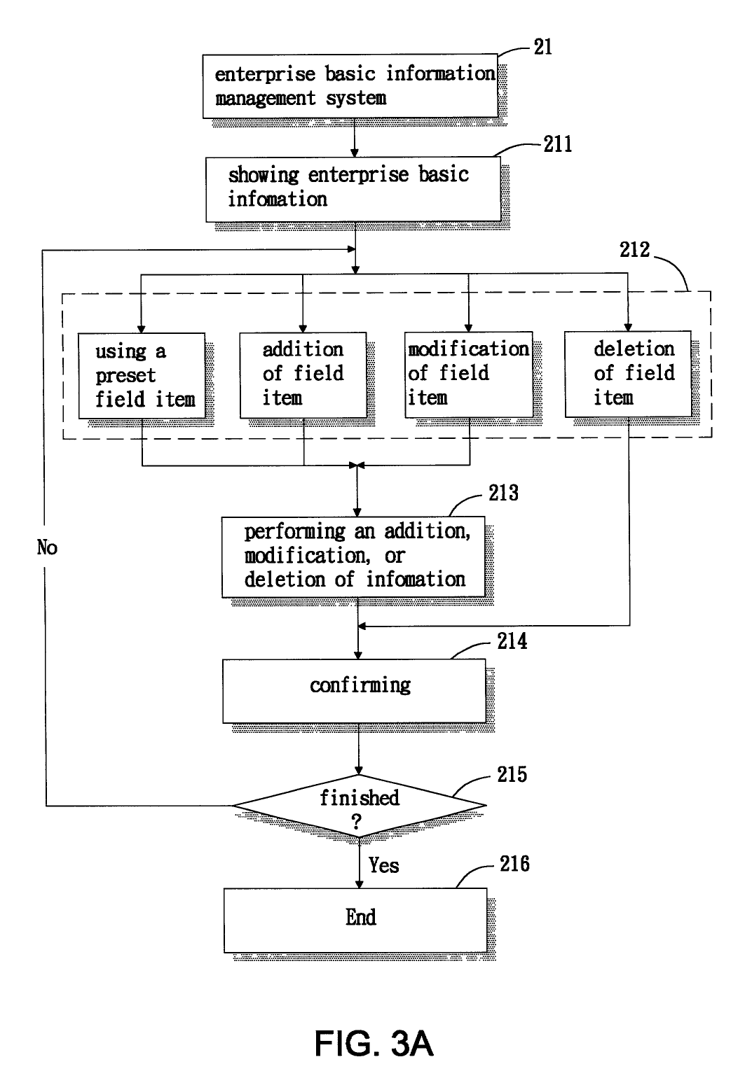

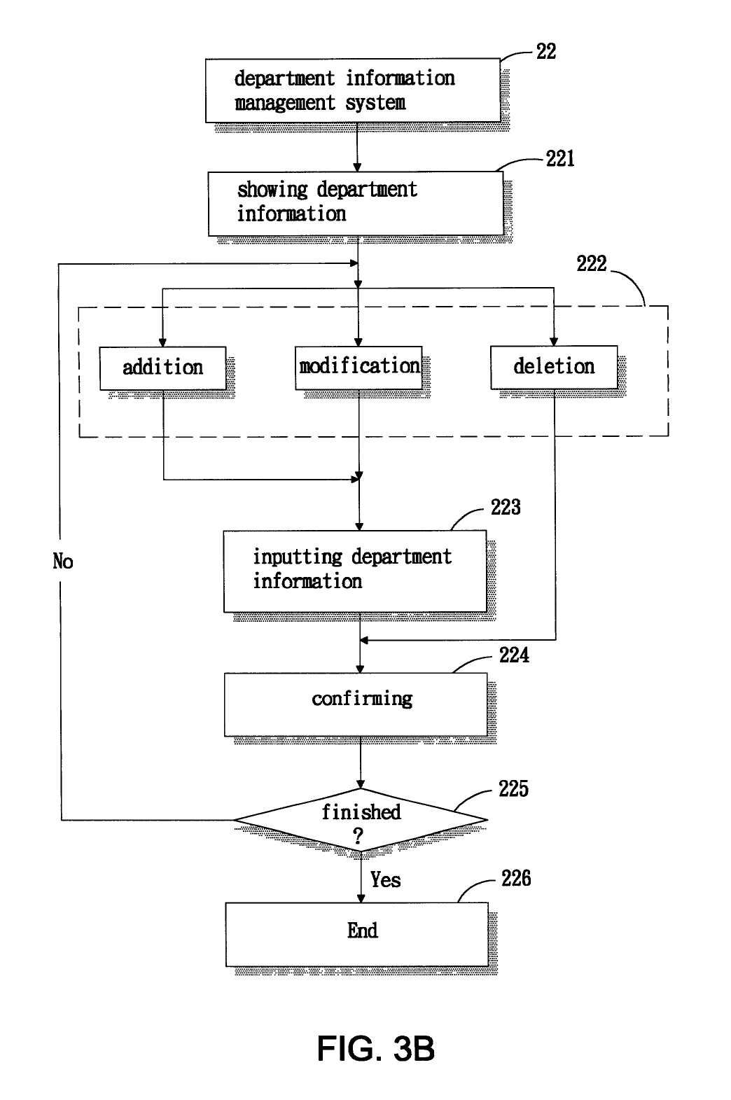

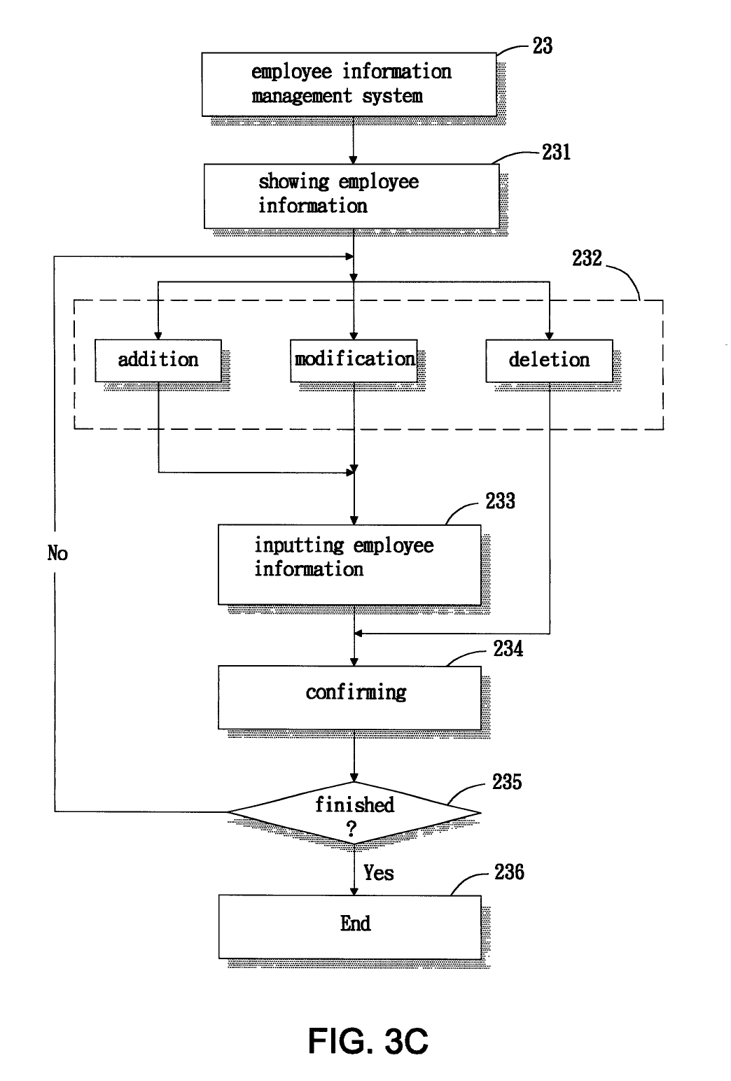

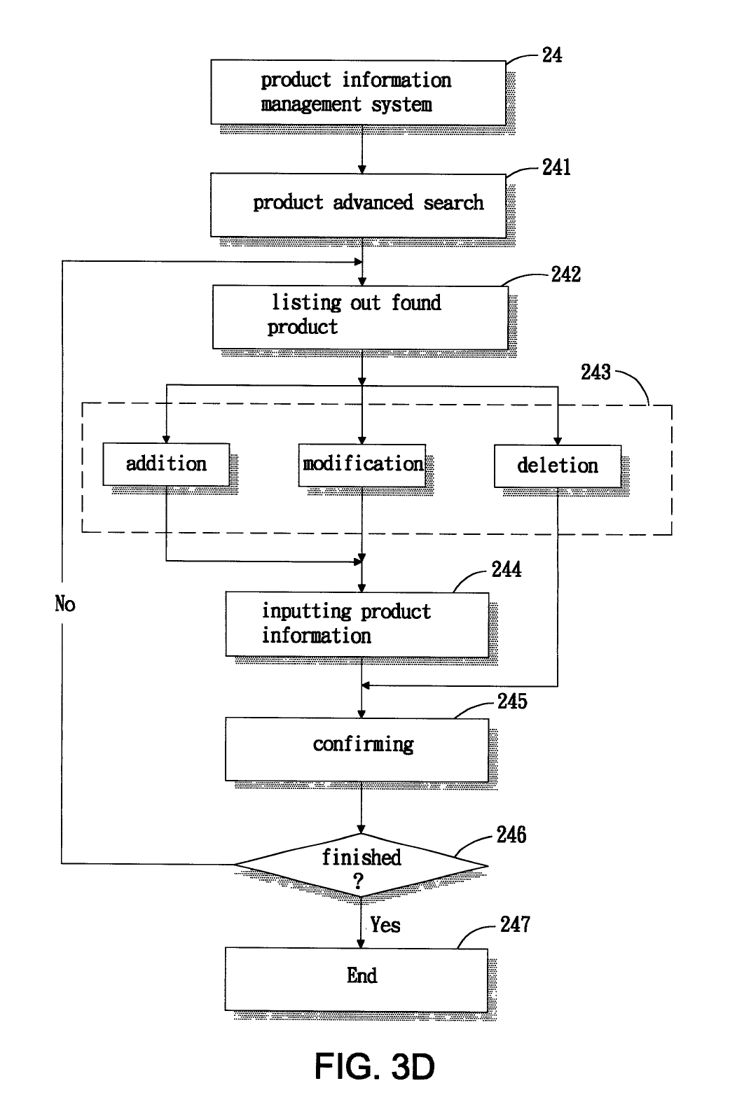

Referring to FIG. 3, a block diagram shows the enterprise information management system in accordance with an embodiment of the present invention. The enterprise information management system 20 comprises: an enterprise basic information management system 21, a department information management system 22, an employee information management system 23, and a product information management system 24. The enterprise basic information management system 21 is principally for the trader of the enterprise to set up and carry out maintenance of basic information comprising the name of the enterprise, its address, telephone number, and trading model. The department information management system 22 is principally for the trader of the enterprise to set up and carry out maintenance of the enterprise department information such as engineer department, business department or finance department. The employee information management system 23 is principally directed to manage and carry out maintenance of the information related to the enterprise internal employees. The product information management system 24 is principally directed to manage the enterprise product information, such as product items, product models, and product prices.

Referring to FIG. 3A, a flow chart shows the enterprise basic information management in accordance with an embodiment of the present invention. In the present invention, the trader when setting up the business web site, first has to set up the basic information of the enterprise in the database of the server 1. The enterprise basic information management system 21 of the present invention then can add, modify, or delete the enterprise basic information in the “presetting” field; it can also add, modify, or delete the field item to adapt to the situation of the enterprise. Thus, all the information that are set up and on which are carried out maintenance are saved in the data base, and has to be displayed on the enterprise information web page of the business web site 2. The process that is performed by the enterprise basic information management system 21 comprises:

(a) showing the enterprise basic information of the data base (step 211);

(b) either using a preset field item, or performing an addition, modification or deletion of field items of the enterprise basic information (step 212); if a deletion of field item is performed, then passing to step (d), otherwise executing the next step;

(c) performing an addition, modification or deletion of the information in the enterprise basic information field (step 213);

(d) confirming, when the confirmation is achieved then saving the enterprise basic information in the data base, and showing the enterprise basic information on the enterprise basic information web page of the business web site 2;

(e) checking whether the addition, modification or deletion are finished (step 215); if it is not finished, then repeating step (a) through step (e), otherwise executing the next step; and

(f) the addition, modification or deletion of enterprise basic information is finished (step 216).

According to the present invention, the fields that are preset for the enterprise basic information comprise:

an enterprise name field, including Chinese and English name and acronym or abbreviated name;

an enterprise code field;

an enterprise address field, including country, state/province, city, and post code;

a telephone/fax field, including telephone number, mobile phone number, and fax number;

an enterprise internet address field;

an enterprise information field, including capital amount, employee amount, and enterprise type;

a person in charge field, including person in charge name, his/her telephone extension, and his/her email address;

a liaison person field, including liaison person name, his/her position, telephone extension and email address;

a receipt field, including type of receipt, receipt addressee, and receipt address;

a payment field, including payment address, and description of payment conditions; and

a trading type, including trading method, description of trading conditions, trading currency, payment way, description of payment conditions, trading date, and tax rate.

In order to adapt to the need of an international business, conglomerate enterprise information can be also set up in the present invention, such that resource circulation can be obtained.

Referring now to FIG. 3B, a flow chart shows the department information management according to an embodiment of the present invention. The process performed by the department information management system 22 comprises:

(a) showing the enterprise department information of the database (step 221);

(b) performing an addition, modification, or deletion of a department (step 222); if a deletion of department is performed, then passing to step (d), otherwise executing the next step;

(c) inputting department information (step 223), including department name, department code, and department description;

(d) confirming (step 224), if the confirmation is achieved, then saving the department information in the database;

(e) checking whether the department addition, modification, or deletion is finished (step 225), if it is not achieved, then repeating step (a) through step (e); and

(f) department addition, modification, or deletion is finished.

Referring now to FIG. 3C, a flow chart shows the employee information management according to an embodiment of the present invention. The process performed by the employee information management system 23 comprises:

(a) showing the employee information of the database (step 231);

(b) performing an addition, modification, or deletion of employee information (step 232); if a deletion of employee information is performed, then passing to step (d), otherwise executing the next step;

(c) inputting employee information (step 233), including name, department, and employee number;

(d) confirming (step 234), when the confirmation is achieved, then saving employee information in the database;

(e) checking whether the addition, modification, or deletion of employee information is finished (step 235); if it is not finished, then repeating step (a) through step (e); and

(f) the addition, modification, or deletion of employee information is finished (step 236).

In the embodiment of the present invention, the fields that are preset for the employee information comprise:

an employee name field, including Chinese and English names;

a department field;

a position field;

an employee number field;

a telephone number field, including extension number, fax number, and mobile phone number; and

an employee basic information field, including ID number, residence address, family member, educational background, professional experience, and interests.

Referring now to FIG. 3D, a flow chart shows the enterprise product information management according to an embodiment of the present invention. The process performed by the product information management system 24 comprises:

(a) entering a product advanced search (step 241), the type of search comprising either by product name, by product code or by product type, or by directly selecting the product icon;

(b) listing out the found product item (step 242);

(c) performing an addition, modification, or deletion of product item (step 243); if a deletion of product item is performed, then passing to step (e), otherwise executing the next step;

(d) inputting product related information (step 244), including product name, product type or product picture;

(e) confirming (step 245), when the confirmation is achieved, then saving the product information in the database, and showing the product information on the product information web page of the business web site 2;

(f) checking whether the addition, modification, or deletion of product information is finished (step 246); if it is not finished, then repeating step (b) through step (f); and

(g) the addition, modification, or deletion of product information is finished (step 247).

In the present invention, the fields that are preset for the product information comprise:

a product name field;

a product code field;

a product type field;

a product model field;

a product amount field;

a product sale price field; and

a product description field.

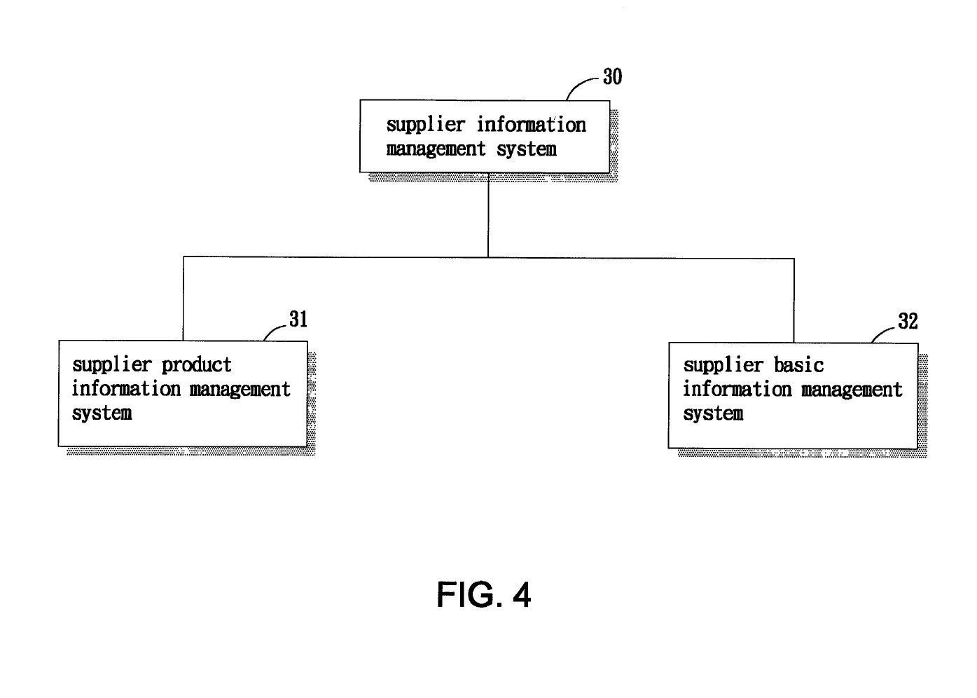

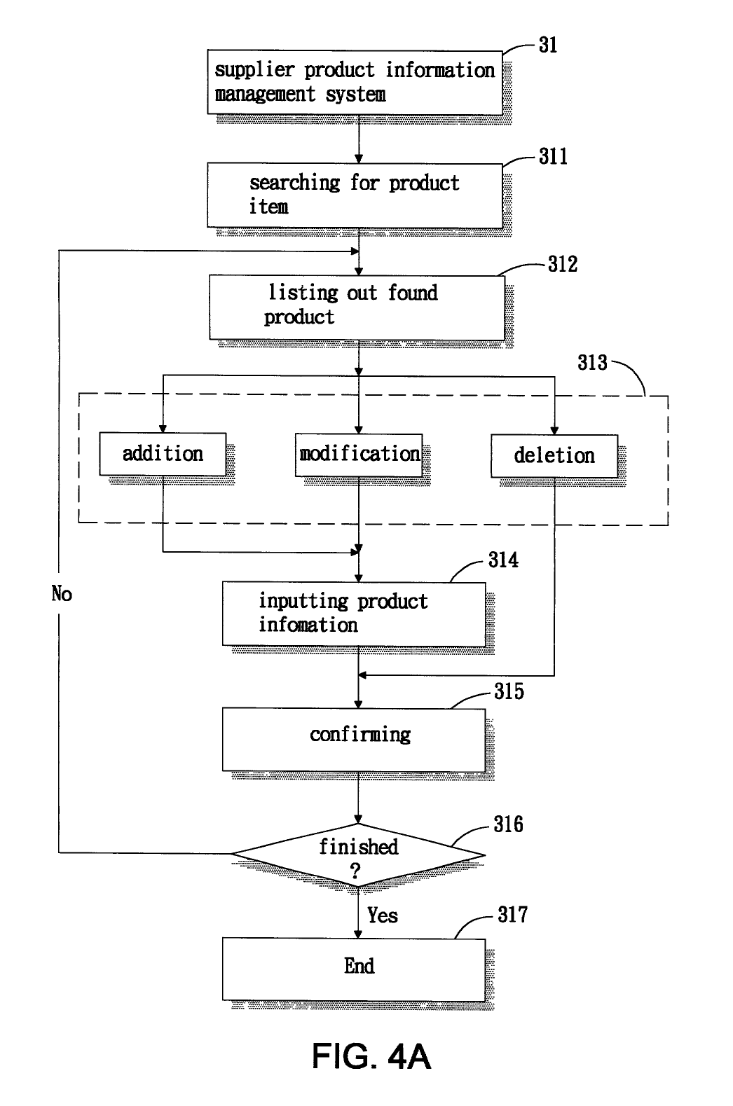

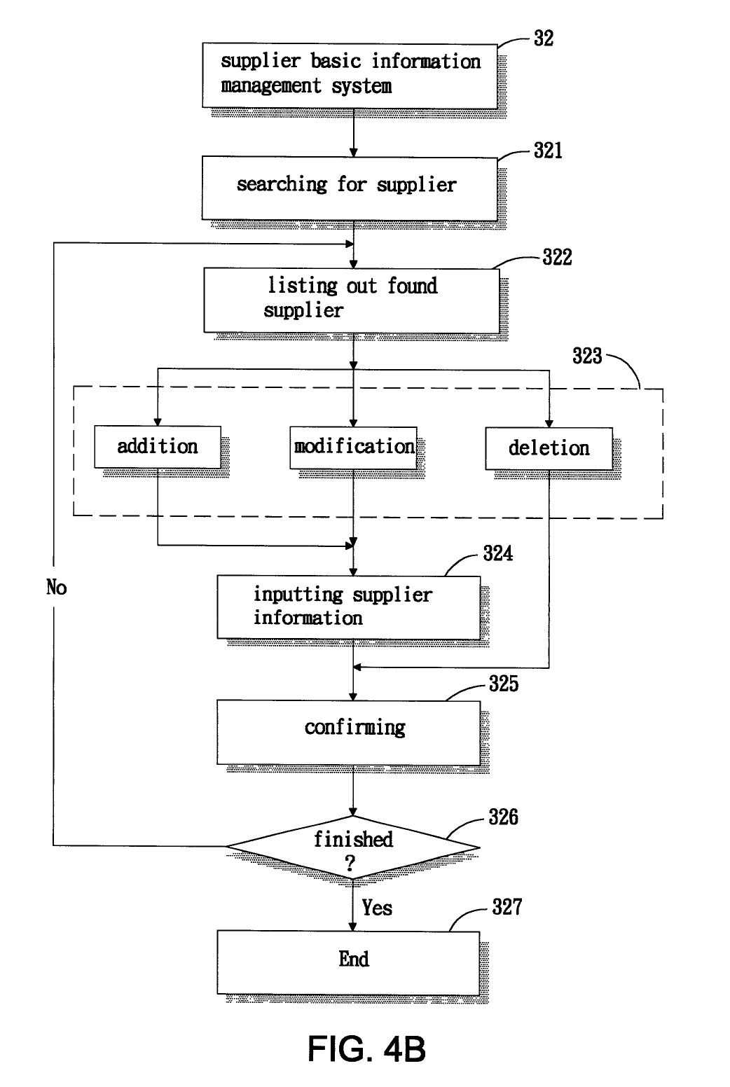

Referring now to FIG. 4, a block diagram shows the supplier management system according to an embodiment of the present invention. The supplier information management system 30 is principally for the trader of the enterprise to set up and carry out maintenance of a supplier basic information. The supplier information management system 30 comprises a supplier product information management system 31 and a supplier basic information management system 32. Within the supplier information management system 30, the supplier product information management system 31 is principally directed to integrate all of the supplier product information, such that the enterprise purchase employee can conveniently search for the desired product items. In turn, the supplier basic information management system 32 is directed to the management of the supplier basic information. When the supplier desires to sell its product to the trader, the supplier must first go on the business web site 2 for inputting its basic information and product items in the database. The present invention then can automatically integrate the foregoing information in the supplier information management system 30. The trader does not need to input any other supplier basic information and product items. The supplier information management system 30 is principally for the trader to manage and carry out maintenance of the supplier information. The trader can also input manually the supplier related information.

Referring now to FIG. 4A, a flow chart shows the supplier product information management according to an embodiment of the present invention. The process performed by the supplier product information management system 31 comprises:

(a) searching for a desired product item that should be managed in the database (step 311); the search can be according to the product name, product condition and product type;

(b) listing out the found product item (step 312);

(c) performing an addition, modification, or deletion of product item or product content (step 313); if the deletion of product item is performed, then passing to step (e), otherwise executing the next step;

(d) inputting the product related information (step 314), wherein the preset fields of the supplier product information are similar to the preset fields of the enterprise product information, and thus does not need further description;

(e) confirming (step 315), when the confirmation is achieved then saving the product information in the database;

(f) checking whether the supplier product information management is finished (step 316); if it is not finished, then repeating step (b) through step (f); and

(g) the supplier product information management is finished (step 317).

The supplier product information management system 31 is for the trader of the enterprise to carry out a management according to the desired products to be purchased, or the products that could be purchased in the future, or the products that would be hypothetically purchased. The supplier product information management system 31 thus classifies and manages the addition of all the product items, and does not classify and manage the addition of suppliers. As a result, all of the supplier product items can be integrated such that an unified purchase and inquiry and negotiation process can be carried out, and the drawbacks of purchase and inquiry and negotiation process separately vis-a-vis each of the suppliers can be eliminated.

Referring now to FIG. 4B, a flow chart shows the supplier basic information management according to an embodiment of the present invention. The supplier basic information management system 32 is for the trader to manage according to the supplier basic information and qualifications. The process that is performed by the supplier basic information management system 32 comprises:

(a) searching for a desired supplier that is to be managed (step 321), the search can be according to the supplier type;

(b) listing out the found supplier (step 322);

(c) performing an addition, modification, or deletion of the supplier information (step 323); if the deletion is performed, then passing to step (e), otherwise executing the next step;

(d) inputting the supplier related information(step 324), including supplier basic information, credibility level of the supplier, or online allotted time of the supplier, etc.;

(e) confirming (step 325), when the confirmation is achieved, then saving the supplier information in the database;

(f) checking whether the supplier information management is finished (step 326); if it is not finished, then repeat step (b) through step (f); and

(g) the supplier information management is finished.

In the present invention, the fields of the supplier related information comprise:

a supplier name field, including Chinese and English name;

a supplier liaison person field, including the liaison person name, telephone number, fax number, and email address;

a supplier type field;

a supplier credibility level field;

a supplier qualification state field;

a supplier online date field; and

a supplier offline date field.

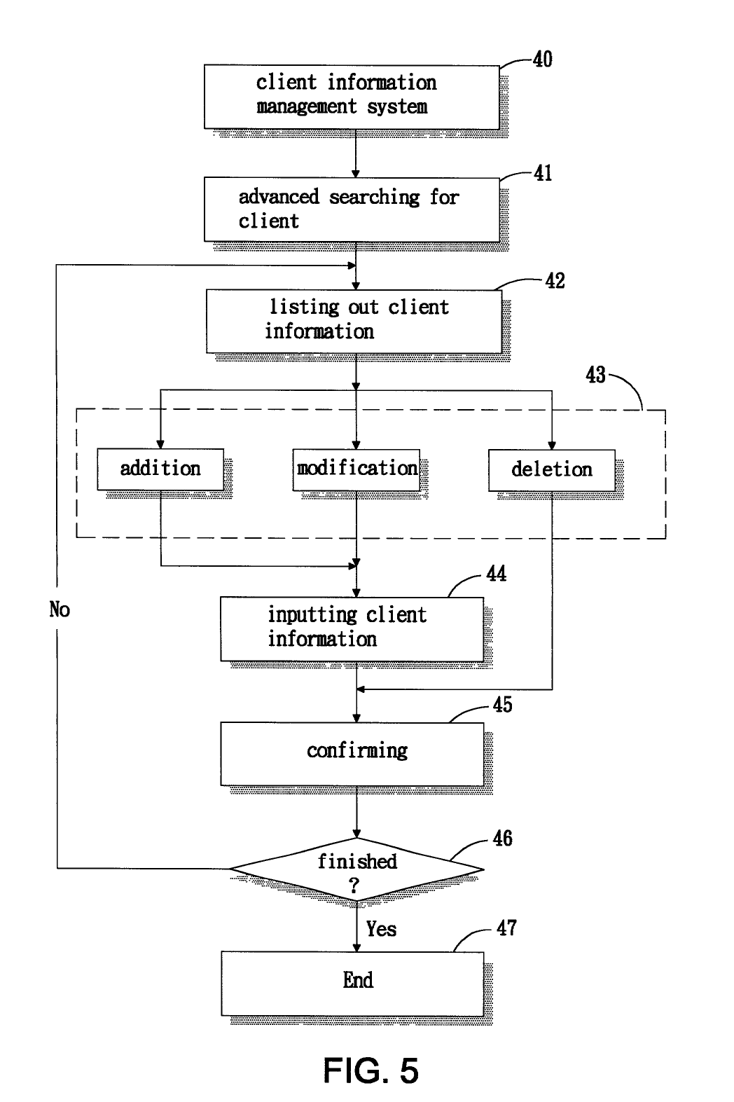

Referring now to FIG. 5, a flow chart shows the client information management according to an embodiment of the present invention. The client information management system 40 of the present invention is principally for the trader to control and manage the client basic information and qualifications. The process that is performed by the client information management system 40 comprises:

(a) searching for a client information (step 41), the search of the desired client can be according to the client type or client enterprise type;

(b) listing out the found client information (step 42);

(c) performing an addition, modification or deletion of the client information (step 43); if the deletion is performed, then passing to step (e), otherwise executing the next step;

(d) inputting the client related information (step 44); the client information fields being similar to those of the supplier are thus not described hereafter;

(e) confirming (step 45), when the confirmation is achieved, then saving the client information in the database;

(f) checking whether the client information management is finished (step 46); if it is not finished, then repeating step (b) through step (f); and

(g) the client information management is finished (step 47).

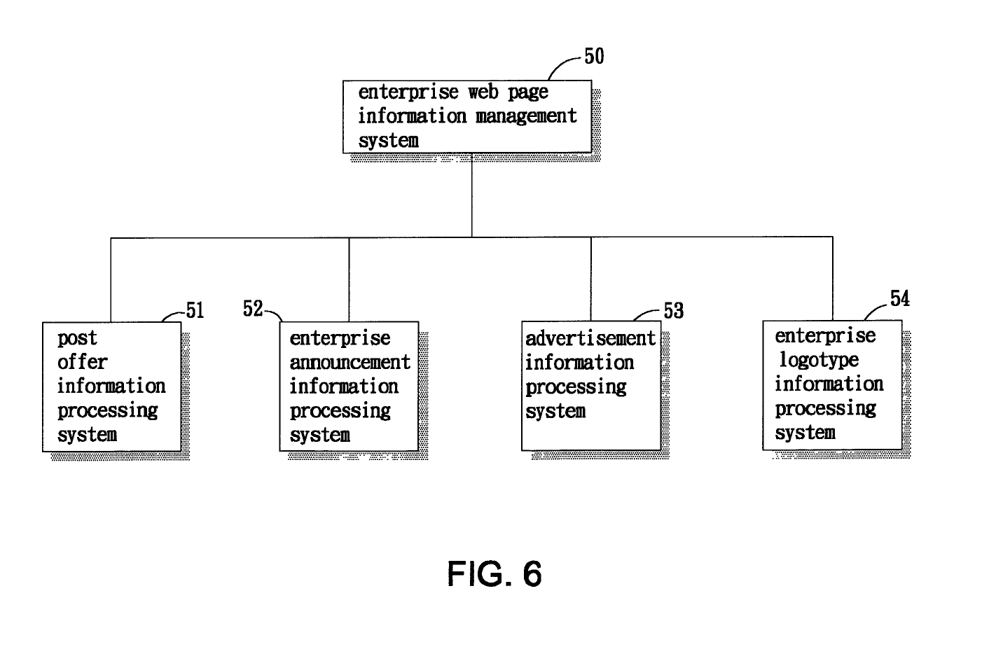

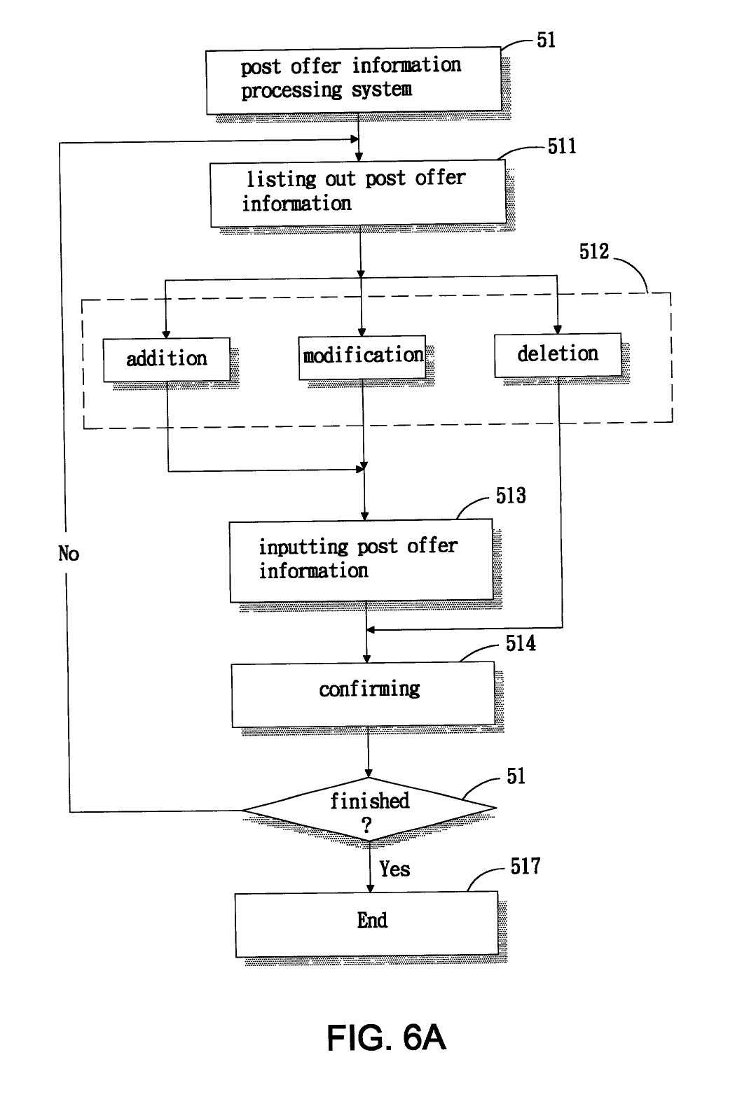

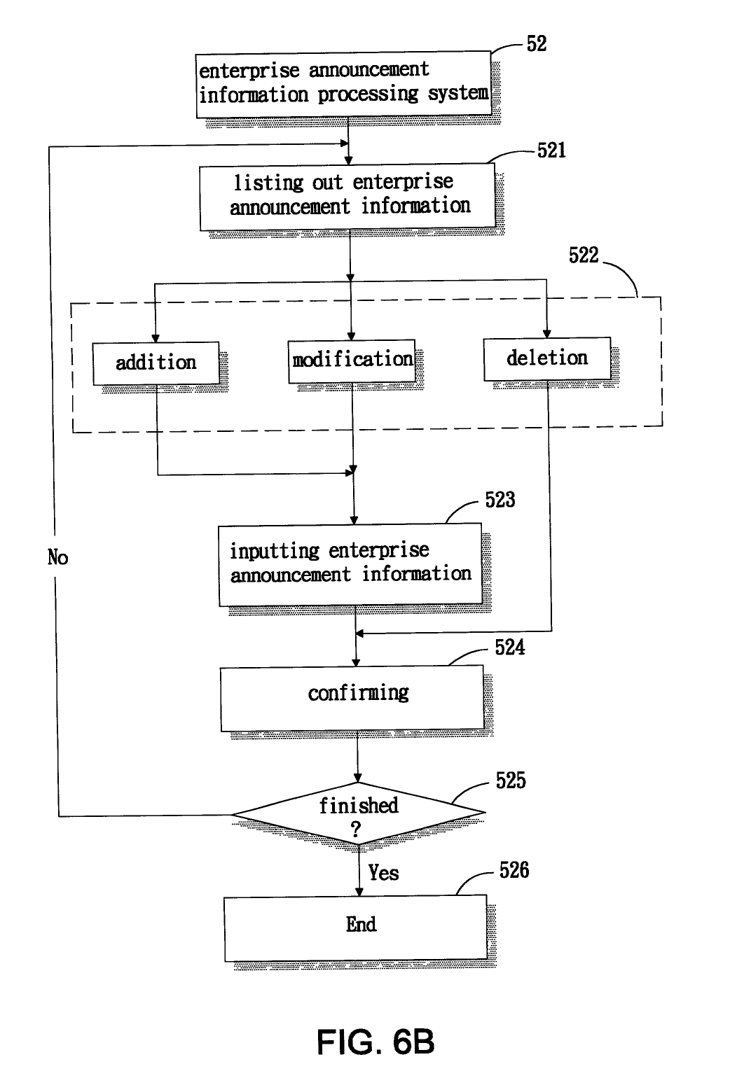

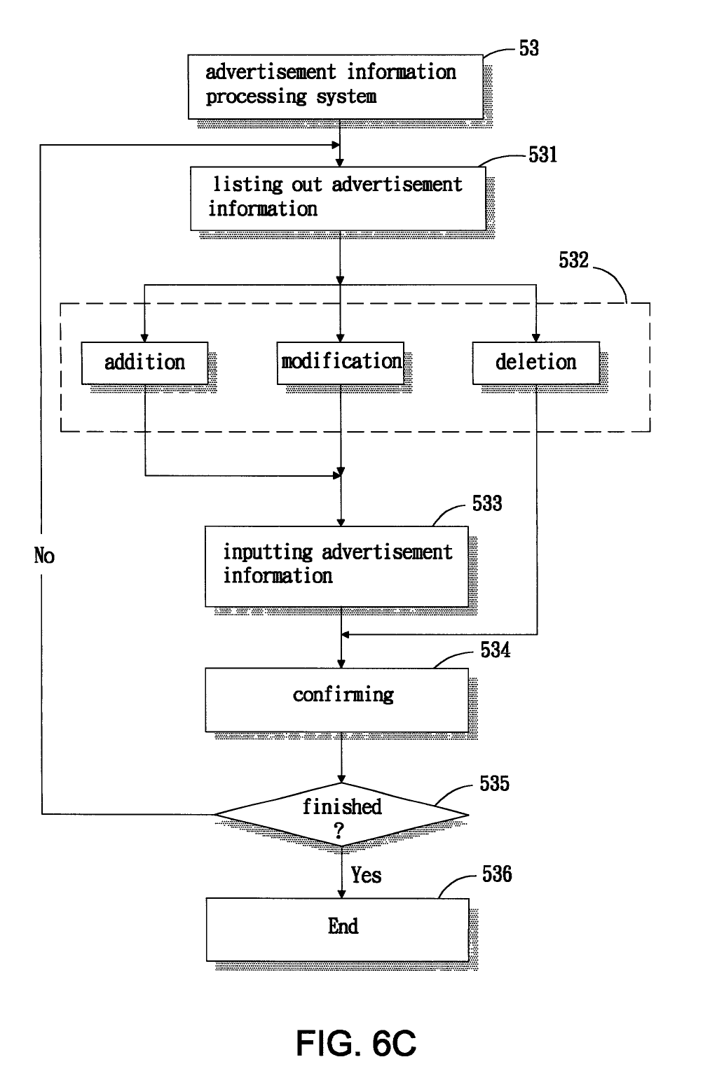

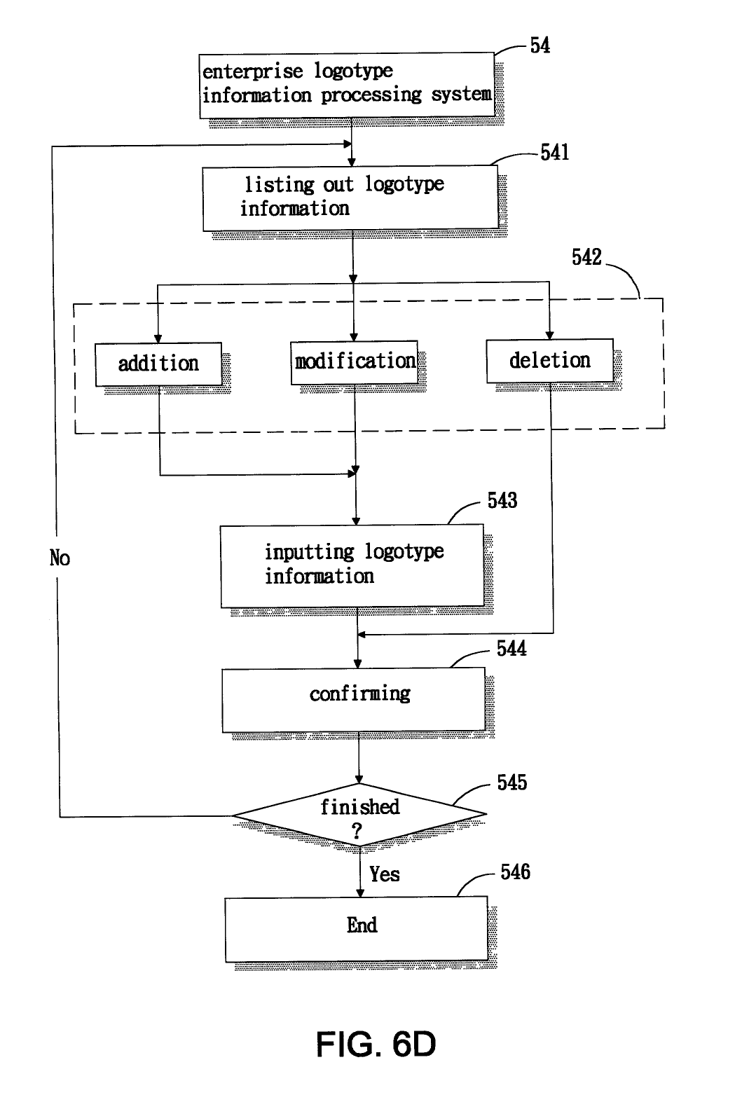

Referring now to FIG. 6, a block diagram shows the enterprise web page information management according to an embodiment of the present invention. The enterprise web page information management system 50 of the present invention is principally directed to set up and carry out maintenance of the web page information of the business web site 2. The web page information management system 50 comprises a post offer information processing system 51, an enterprise announcement information processing system 52, a advertisement information processing system 53 and an enterprise logotype information processing system 54. The post offer information processing system 51 is principally directed to register the information related to the posts that are offered by the enterprise on the job offer web page of the business web site 2. The enterprise announcement information processing system 52 is principally directed to display important information vis-à-vis the outward of the enterprise on the announcement web page of the business web site 2. The advertisement information processing system 53 is principally directed to process, on the business web site 2, the registered advertisement information related to the advertised or authorized products of the enterprise. The enterprise logotype information processing system 54 can set up or modify the enterprise logotype or the trademark design.

Referring now to FIG. 6A, a flow chart shows the post offer information processing according to an embodiment of the present invention. The post offer information processing system 51 is principally directed to register the information related to the posts that are offered by the enterprise on the job offer web page of the business web site 2, such that the trade can be aided in the search of the adapted candidate profile. The process performed by the post offer information processing system 51 comprises:

(a) listing out the post offer information of the database (step 511);

(b) performing an addition, modification, or deletion of post offer information (step 512); if a deletion is performed, then passing to step (d), otherwise executing the next step;

(c) inputting post offer information (step 513), including liaison person, post description, or registration limit date;

(d) confirming (step 514), when the confirmation is achieved, then saving the post offer information in the database, and registering the post offer information on the post offer web page of the business web site according to the registration limit date;

(e) checking whether the addition, modification, or deletion of post offer information is finished (step 515); if it is not finished, then repeating step (a) through step (e); and

(f) the addition, modification, or deletion of post offer information is finished. (step 516).

In the present invention, the fields that are preset for the post offer information comprise:

a liaison person field, including liaison person name, liaison person telephone number and email address;

a registration limit date field, including registration and closing dates;

a post offer type field, including post title and post type; and

a post offer description field.

Referring now to FIG. 6B, a flow chart shows the enterprise announcement information processing according to an embodiment of the present invention. The enterprise announcement information processing system 52 is directed to process the information of announcement that are made by the enterprise to the enterprise outward, wherein the announcement information is displayed on the enterprise announcement web page of the business web site 2. The process that is performed by the enterprise announcement information processing system 52 comprises:

(a) listing out the enterprise announcement information of the database (step 521);

(b) performing an addition, modification, or deletion of enterprise announcement information (step 522); if a deletion of announcement information is performed, then passing to step (d), otherwise executing the next step;

(c) inputting the enterprise announcement information (step 523), including its subject, its summary, and its subject matter or registration limit date;

(d) confirming (step 524), when the confirmation is achieved, then saving the announcement information in the database and, according to the registration limit date, registering the announcement information on the enterprise announcement web page of the business web site;

(e) checking whether the addition, modification, or deletion of enterprise announcement information is finished; if it is not finished, then repeating step (a) through step (e); and

(f) the addition, modification, or deletion of enterprise announcement information is finished.

The fields that are preset for the enterprise announcement information comprise:

an announcement subject field;

an announcement type field, such as new announcement or popular announcement;

an announcement limit date field, including registration and closing dates;

an announcement level field, such as urgent announcement or ordinary announcement;

an announcement subject matter field; and

an announcement summary field.

Referring now to FIG. 6C, a flow chart shows the advertisement information processing according to an embodiment of the present invention. The advertisement information processing system 53 is directed to process the advertisement web page of the business web site 2. The process that is performed by the advertisement information processing system 53 comprises:

(a) listing out the advertisement information of the database (step 531);

(b) performing an addition, modification, or deletion of advertisement information (step 532); if a deletion of advertisement information is performed, then passing to step (d), otherwise executing the next step;

(c) inputting an advertisement information (step 533), including its subject matter, its pictures, web linking addresses or registration limit date;

(d) confirming (step 534), when the confirmation is achieved, then saving the advertisement information in the database and, according to the registration limit date, registering the advertisement information on the business web site;

(e) checking whether the addition) modification, or deletion of advertisement information is finished (step 535); if it is not finished, then repeating step (a) through step (e); and

(f) the addition, modification, or deletion of advertisement information is finished (step 536).

The fields that are preset for the advertisement information comprise:

an advertisement type field, such as words or animations;

an enterprise number field, which is the number of the enterprise registering the advertisement;

an advertisement subject field;

an advertisement limit date field, including registration and closing dates;

an advertisement design field, which can receive design, animation or picture/sound files;

an advertisement web linking addresses field; and

an advertisement summary field.

Referring now to FIG. 6D, a flow chart shows the enterprise logotype information processing according to an embodiment of the present invention. The enterprise logotype information processing system 54 is directed to process the enterprise logotype or trademark design of the business web site 2. The process that is performed by the enterprise logotype information processing system 54 comprises:

(a) listing out the enterprise logotype information of the database (step 541);

(b) performing an addition, modification, or deletion of enterprise logotype information (step 542); if a deletion of enterprise logotype information is performed, then passing to step (d), otherwise executing the next step;

(c) inputting an enterprise logotype information (step 543), including the subject matter, the pictures, and web linking addresses or registration limit date;

(d) confirming (step 544), when the confirmation is achieved, then saving the enterprise logotype information in the database, and displaying the enterprise logotype information on the business web site;

(e) checking whether the addition, modification, or deletion of enterprise logotype information is finished (step 545); if it is not finished, then repeating step (a) through step (e); and

(f) the addition, modification, or deletion of enterprise logotype information is finished (step 546).

The fields that are preset for the enterprise logotype information comprise:

an enterprise logotype subject field;

an enterprise logotype design field, which can receive the design, animation or picture/sound files;

an enterprise logotype web linking address field; and

an enterprise logotype summary field.

In conclusion, the foregoing description of embodiment and examples of the present invention reveals at least the following advantages. The present invention can simply set up and manage the enterprise internal information, such that an electronic business can be efficiently carried out while the cost is reduced.

Furthermore, the present invention can set up, according to the need, an exclusive web site to carry out an efficient electronic business which can simplify the purchase and sale processes.

Furthermore, according to the actual need of the enterprise, the present invention can choose different functional elements of the order/manufacture model, and generate electronic processes of replenishment/sale/stock.

Furthermore, the present invention can integrate, through the setup of a web site, the enterprise internal resources with the upstream supplier and downstream client resources to obtain a replenishment/sale/stock management.

As understood by a person skilled in the art, the foregoing description of the preferred embodiment and examples of the present invention are only illustrative rather than limiting. Revisions and modifications may be made to processes, materials, and structures through which is provided the foregoing embodiment of the present invention without departing from the spirit and scope of the present invention as defined by the following appended claims.

What is claimed is:

1. An online trade web site management system that is set up in a web site of an enterprise, wherein a trader of the enterprise can, through internet, carry out a purchase with at least one supplier and a sale with at least one client, the online trade web site management system comprising:
an enterprise information management system that is directed to set up and carry out maintenance of an enterprise basic information;
a supplier information management system that is directed to set up and carry out maintenance of a supplier basic information;
a client information management system that is directed to set up and carry out maintenance of a client basic information; and
an enterprise web page information management system that is directed to set up and carry out maintenance of information that is related to a plurality of web pages of the business web site.

2. The online trade web site management system of claim 1, wherein the enterprise information management system comprises:
an enterprise basic information management system that principally set up and carries out maintenance of the enterprise basic information;
a department information management system that principally set up and carries out maintenance of information of each department of the enterprise;
an employee information management system that principally manages and carries out maintenance of the enterprise internal employee information; and
a product information management system that principally manages product information of products sale by the enterprise.

3. An enterprise basic information management process executed by the enterprise basic information management system inside the enterprise information management system of claim 2, wherein the enterprise information management system can perform an addition, modification, or deletion of the enterprise basic information that is preset in a plurality of fields, and also perform an addition, modification, or deletion of a plurality of field items, wherein the concerned information is shown on an enterprise information web page of the business web site, the enterprise basic information management process comprising:
(a) showing the enterprise basic information;
(b) either using a preset field item, or performing an addition, modification or deletion of the enterprise basic information field item; if a field item deletion is performed, then going to step (d), otherwise executing the next step;
(c) performing an addition, modification or deletion of the information in the enterprise basic information field;
(d) confirming;
(e) checking whether the addition, modification or deletion is finished; if it is not finished, then repeating step (a) through step (e), otherwise executing the next step; and
(f) the addition, modification or deletion of enterprise basic information is finished.

4. The enterprise basic information management process of claim 3, wherein the fields that are preset for the enterprise basic information in step (b) comprise:
an enterprise name field, including Chinese and English name and acronym or abbreviated name;
an enterprise number field;
an enterprise address field, including country, state/province, city, and post code;
a telephone/fax field, including telephone number, mobile phone number, and fax number;
an enterprise internet address field;
an enterprise information field, including capital amount, employee amount, and enterprise type;
a person in charge field, including person in charge name, his/her telephone extension, and his/her email address;
a liaison person field, including liaison person name, his/her position, telephone extension and email address;
a receipt field, including type of receipt, receipt addressee, and receipt address;
a payment field, including payment address, and description of payment conditions; and
a trading type, including trading method, description of trading conditions, trading currency, payment way, description of payment conditions, trading date, and tax rate.

5. A department information management process executed by the department information manageme0nt system within the enterprise information management system of claim 2, wherein the department information management process comprises:
(a) listing out enterprise department information;
(b) performing an addition, modification, or deletion of a department; if a deletion of department is performed, then passing to step (d), otherwise executing the next step;
(c) inputting department information, including department name, department code, and department description;
(d) confirming;
(e) checking whether the addition, modification, or deletion of department is finished, if it is not finished, then repeating step (a) through step (e); and
(f) the addition, modification, or deletion of department is finished.

6. An employee information management process executed by the employee information management system inside the enterprise information management system of claim 2, wherein the employee information management process comprises:
(a) showing all of the employee information;
(b) performing an addition, modification, or deletion of employee information; if a deletion of employee information is performed, then passing to step (d), otherwise executing the next step;
(c) inputting employee information;
(d) confirming;
(e) checking whether the addition, modification, or deletion of employee information is finished; if it is not finished, then repeating step (a) through step (e); and
(f) the addition, modification, or deletion of employee information is finished.

7. The employee information management process of claim 6, wherein the fields that are preset for the employee information in step (c) comprise:
an employee name field, including Chinese and English names;
a department field;
a position field;
an employee number field;
a telephone number field, including extension number, fax number, and mobile phone number; and
an employee basic information field, including ID number, residence address, family member, educational background, professional experience, and interests.

8. A product information management process executed by the product information management system inside the enterprise information management system of claim 2, wherein the product information management process comprises:
(a) entering a product item advanced search, the type of search comprising either by product name, by product code or by product type, or by directly selecting the product icon;
(b) listing out the found product item;
(c) performing an addition, modification, or deletion of product item; if a deletion of product item is performed, then passing to step (e), otherwise executing the next step;
(d) inputting product information;
(e) confirming, when the confirmation is achieved, showing the product information on a product information web page of the business web site;
(f) checking whether the addition, modification, or deletion of product information is finished; if it is not finished, then repeat step (b) through step (f); and
(g) the addition, modification, or deletion of product information is finished.

9. The product information management process of claim 8, wherein the fields that are preset for the product information in step (d) comprise:
a product name field;
a product code field;
a product type field;
a product model field;
a product amount field;
a product sale price field; and
a product description field.

10. The online trade web site management system of claim 1, wherein the supplier information management system comprises:
a supplier product information management system that integrates all of the supplier product information, such that a purchase employee of the enterprise can conveniently search for the desired product item that is to be purchased; and
a supplier basic information management system that manages a supplier basic information.

11. A supplier product information management process executed by the supplier product information management system inside the supplier information management system of claim 10, wherein the supplier product information management process comprises:
(a) searching for a desired product item that should be managed; the search can be according to the product name, product condition and product type;
(b) listing out the found product item;
(c) performing an addition, modification, or deletion of product item or product data; if the deletion of product item is performed, then passing to step (e), otherwise executing the next step;
(d) inputting product information;
(e) confirming;
(f) checking whether the supplier product information management is finished; if it is not finished, then repeating step (b) through step (f); and
(g) the supplier product information management is finished.

12. The supplier product information management process of claim 11, wherein the fields that are preset for the supplier product information in step (d) comprise:
a product name field;
a product code field;
a product type field;
a product model field;
a product amount field;
a product sale price field; and
a product description field.

13. A supplier basic information management process executed by the supplier basic information management system inside the supplier information management system of claim 10, wherein the supplier basic information management process comprises:
(a) searching for a supplier, wherein the search can be according to the supplier type;
(b) listing out the found supplier related information;
(c) performing an addition, modification, or deletion of the supplier information; if a deletion is performed, then going to step (e), otherwise executing the next step;
(d) inputting the supplier related information;
(e) confirming;
(f) checking whether the supplier information management is finished; if it is not finished, then repeating step (b) through step (f); and
(g) the supplier information management is finished.

14. The supplier basic information management process of claim 13, wherein the fields of the supplier information in step (d) comprise:
a supplier name field, including Chinese and English name;
a supplier liaison person field, including the liaison person name, telephone number, fax number, and email address;
a supplier type field;
a supplier credibility level field;
a supplier qualification state field;
a supplier online date field; and
a supplier offline date field.

15. A client information management process executed by the client information management system inside the online trade web site management system of claim 1, wherein the client information management process comprises:
(a) searching for a client information, wherein the search of the client information can be according to a client type or client enterprise type;
(b) listing out the found client information;
(c) performing an addition, modification or deletion of the client information; if the deletion is performed, then passing to step (e), otherwise executing the next step;
(d) inputting the client related information;
(e) confirming;
(f) checking whether the client information management is finished; if it is not finished, then repeating step (b) through step (f); and
(g) the client information management is finished.

16. The client information management process of claim 15, wherein the fields of client information in step (d) comprise:
a client name field, including Chinese and English name;
a client liaison person field, including the liaison person name, telephone number, fax number, and email address;
a client type field;
a client credibility level field;
a client qualification state field;
a client online date field; and
a supplier offline date field.

17. The online trade web site management system of claim 1, wherein the web page information management system comprises:
a post offer information processing system that registers an information of a plurality of post offers of the enterprise on a post offer web page of the business web site;
an enterprise announcement information processing system that announces important information of the enterprise on an enterprise announcement web page of the business web site;
an advertisement information processing system that processes enterprise product advertisements, or advertisements authorized to be registered, on the business web site; and
an enterprise logotype information processing system that sets up or modifies an enterprise logotype or trademark design.

18. A post offer information processing executed by the post offer information processing system inside the web page information management system of claim 17, wherein the post offer information processing comprises:
(a) listing out post offer information;
(b) performing an addition, modification, or deletion of post offer information; if a deletion is performed, then going to step (d), otherwise executing the next step;
(c) inputting post offer information, including liaison person, post description, or registration limit date;
(d) confirming, when the confirmation is achieved, registering the post offer information on the post offer web page of the business web site according to the registration limit date;
(e) checking whether the addition, modification, or deletion of post offer information is finished; if it is not finished, then repeating step (a) through step (e); and
(f) the addition, modification, or deletion of post offer information is finished.

19. The post offer information processing of claim 18, wherein the fields that are preset for the post offer information in step (c) comprise:
a liaison person field, including liaison person name, liaison person telephone number and email address;
a registration limit date field, including registration and closing dates;
a post offer type field, including post title and post type; and
a post offer description field.

20. An enterprise announcement information processing executed by the enterprise announcement information processing system inside the web page information management system of claim 17, wherein the enterprise announcement information processing comprises:
(a) listing out the enterprise announcement information of the database;
(b) performing an addition, modification, or deletion of enterprise announcement information; if a deletion of announcement information is performed, then passing to step (d), otherwise executing the next step;
(c) inputting the enterprise announcement information;
(d) confirming, when the confirmation is achieved, according to a registration limit date, registering the announcement information on the enterprise announcement web page of the business web site;
(e) checking whether the addition, modification, or deletion of enterprise announcement information is finished; if it is not finished, then repeating step (a) through step (e); and
(f) the addition, modification, or deletion of enterprise announcement information is finished.

21. The enterprise announcement information processing of claim 20, wherein the fields of enterprise announcement information in step (c) comprise:
an announcement subject field;
an announcement type field, such as new announcement or popular announcement;
an announcement limit date field, including registration and closing dates;
an announcement level field, such as urgent announcement or ordinary announcement;
an announcement subject matter field; and
an announcement summary field.

22. An advertisement information processing executed by the advertisement information processing system inside the web page information management system of claim 17, wherein the advertisement information processing comprises:
(a) listing out all of the advertisement information;
(b) performing an addition, modification, or deletion of advertisement information; if a deletion of advertisement information is performed, then passing to step (d), otherwise executing the next step;
(c) inputting an advertisement information;
(d) confirming, wherein when the confirmation is achieved, according to a registration limit date, registering the advertisement information on the business web site;
(e) checking whether the addition, modification, or deletion of advertisement information is finished; if it is not finished, then repeating step (a) through step (e); and
(f) the addition, modification, or deletion of advertisement information is finished.

23. The advertisement information processing of claim 22, wherein the fields that are preset for the advertisement information in step (c) comprise:
an advertisement type field, such as words or animations;
an enterprise number field, which is the number of the enterprise registering the advertisement;
an advertisement subject field;
an advertisement limit date field, including registration and closing dates;
an advertisement design field, which can receive design, animation or picture/sound files;
an advertisement web linking addresses field; and
an advertisement summary field.

24. An enterprise logotype information processing executed by the enterprise logotype information processing system inside the web page information management system of claim 17, wherein the enterprise logotype information processing comprises:
(a) listing out all of the enterprise logotype information;
(b) performing an addition, modification, or deletion of enterprise logotype information; if a deletion of enterprise logotype information is performed, then going to step (d), otherwise executing the next step;
(c) inputting an enterprise logotype information;
(d) confirming, wherein when the confirmation is achieved, registering the enterprise logotype information on the business web site according to a registration limit date;
(e) checking whether the addition, modification, or deletion of enterprise logotype information is finished; if it is not finished, then repeating step (a) through step (e); and
(f) the addition, modification, or deletion of enterprise logotype information is finished.

25. The enterprise logotype information processing of claim 24, wherein the fields that are preset for the enterprise logotype information in step (c) comprise:
an enterprise logotype subject field;
an enterprise logotype design field, which can receive the design, animation or picture/sound files;
an enterprise logotype web linking address field; and
an enterprise logotype summary field.
